(19) United States
(12) Patent Application Publication
(10) Pub. No.: US 2014/0284532 A1
(43) Pub. Date: Sep. 25, 2014

(54) BRIDGE LIFTING SUPPORT BRACKET

(71) Applicant: China Engineering Consultants, Inc., Taipei City (TW)

(72) Inventors: Ching-Lung Liao, Taipei City (TW); Min Chao, Kaohsiung City (TW); Chung-Yue Wang, New Taipei City (TW); Jin-Chung Ma, New Taipei City (TW); Wu-Peng Peng, Taipei City (TW)

(73) Assignee: China Engineering Consultants, Inc., Taipei City (TW)

(21) Appl. No.: 14/224,510

(22) Filed: Mar. 25, 2014

(30) Foreign Application Priority Data
Mar. 22, 2013 (TW) 102110152

(51) Int. Cl. E01D 22/00; B66F 3/46

(52) U.S. Cl. CPC E01D 22/00; B66F 3/46
USPC 254/89 R

(57) ABSTRACT

A bridge lifting support bracket is disclosed, which comprises a supporting mechanism, comprising a bracket having a depressed area at a face thereof and a raising portion disposed at two sides of the bracket, respectively; and at least two jacks, disposed on a bottom face of the raising portions, respectively. As such, a space for receiving a jack properly is secured by digging out a space of a concrete protection layer of a lower structure and using a supporting mechanism cooperating therewith when only a small space or a closely tight bonding with no seam existing between a bridge and a pier, whereby a raising process of the bridge may be safely performed.

### FIELD OF THE INVENTION

The present invention relates to a bridge lifting support bracket, and particularly to such a bracket where a space for receiving a jack properly is secured by digging out a space of a concrete protection layer of a lower structure and using a supporting mechanism cooperating therewith when only a small space or a closely tight bonding with no seam existing between a bridge and a pier, whereby a raising process of the bridge may be safely performed.

### DESCRIPTION OF THE RELATED ART

In the engineering field, an operational station for setting up a jack for a bridge is usually conducted by using a thread anchoring supporting bracket or other supporting systems.

However, this engineering method still has its consideration in construction safety. When an upper structure of the bridge body is under raising process, the weight of the bridge body is transferred and distributed on the jack arranged below the bridge. At this time, a weight load of each of the jacks ranges between tens to hundreds of tone. In addition, the concrete at the anchoring position has a strength which varies largely with the aging problem of the bridge body and the environment it lays around. Therefore, engineering danger factors are largely increased. Along with the defect of the construction operation and the supporting system, such as Improper design and fault construction. Once the jack is failed to properly supported, a chained of effects may be brought about, resulting in an impaired bridge structure, and even an unsafety of lives and fortune in the worst case. Plus with the repair cost, required time and inconvenient traffic, the loss may be inestimable.

In view of this, the drawbacks mentioned above, the inventor of the present invention provides a bridge lifting support bracket, after many efforts and researches to overcome the shortcoming encountered in the prior art.

### SUMMARY OF THE INVENTION

It is an object of the present invention to provide a bridge lifting support bracket, where a space for receiving a jack properly is secured by digging out a space of a concrete protection layer of a lower structure and using a supporting mechanism cooperating therewith when only a small space or a closely tight bonding with no seam existing between a bridge and a pier, whereby a raising process of the bridge may be safely performed.

To achieve the above object, the bridge lifting support bracket comprises a supporting mechanism, comprising a bracket having a depressed area at a face thereof and a raising portion disposed at two sides of the bracket, respectively; and at least two jacks, disposed on a bottom face of the raising portions, respectively.

In an embodiment, the bracket comprises a bottom plate, and a side plate disposed vertically at two sides of the bottom plates, respectively, so that a depressed area is formed on the bottom plate between the two side plates and each of the raising portions are disposed on an outer side face of the side plates, respectively.

In an embodiment, each of the raising portions comprises an extension plate vertically disposed on the side plate, and a plurality of reinforcing plates disposed between the side plates and the extension plate, and each of the jacks are disposed on a bottom face of the extension plate, respectively.

In an embodiment, each of the jacks has a plurality of insets at the bottom side thereof according to a raising altitude.

In an embodiment, a position limiting mechanism is disposed neighboring to the supporting mechanism for safety.

### BRIEF DESCRIPTIONS OF THE DRAWINGS

The present invention will be better understood from the following detailed descriptions of the preferred embodiments according to the present invention, taken in conjunction with the accompanying drawings, in which:

FIG. 1 is a schematic diagram of an outlook of the present invention.

FIG. 2 is a schematic diagram of a side view of the present invention.

FIG. 3 through FIG. 8 are schematic diagrams of using the present invention, respectively.

### DESCRIPTION OF THE PREFERRED EMBODIMENTS

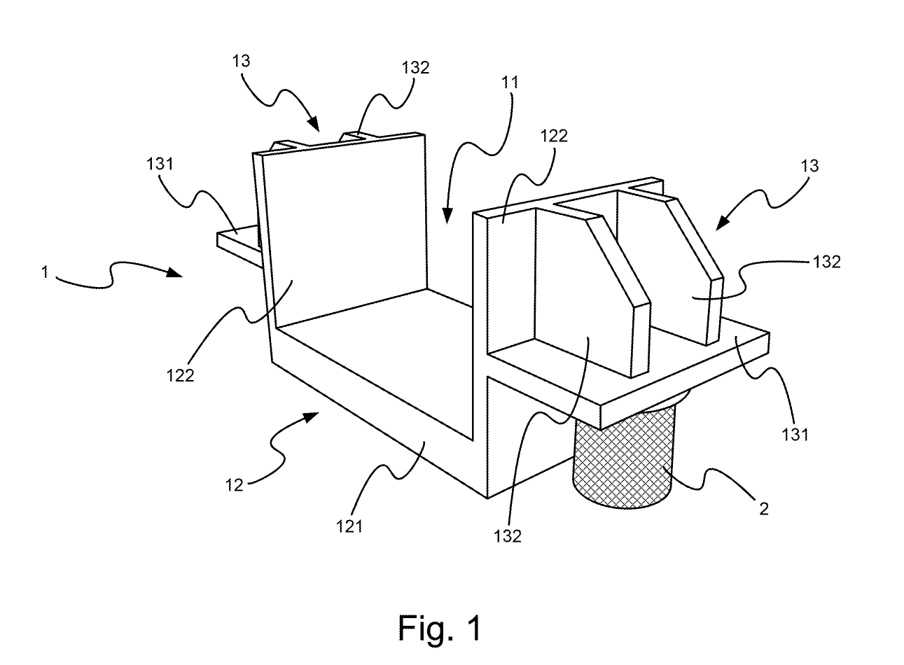

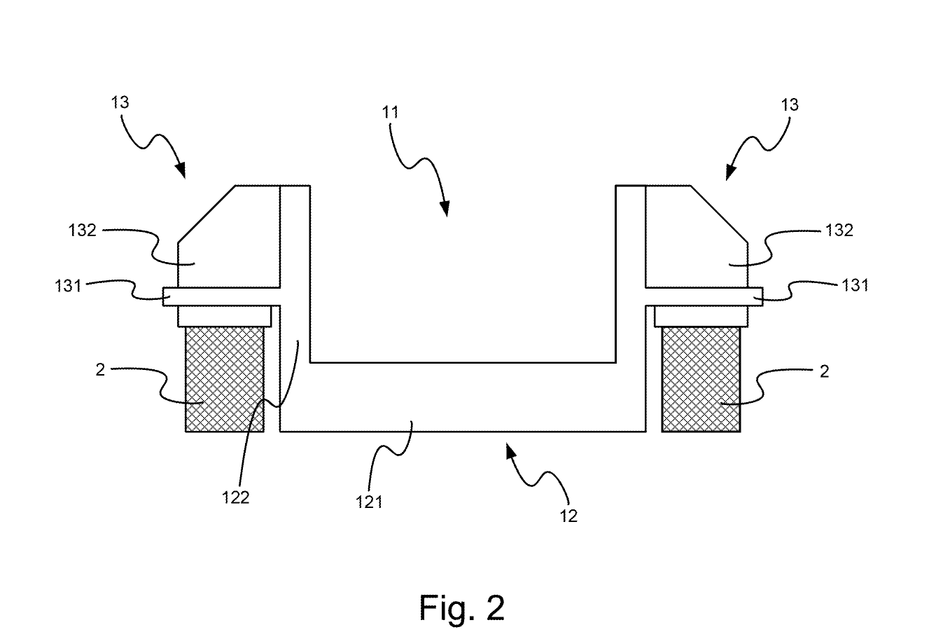

Referring to FIG. 1 and FIG. 2, a schematic diagram of an outlook of the present invention and a schematic diagram of a side view of the present invention are shown, respectively. As shown, the present invention is a bridge lifting support bracket, which comprises a supporting mechanism 1 and at least two jacks 2.

The supporting mechanism 1 comprises a bracket 12 having a depressed area 11 on its one face, and a raising portion 13 disposed on two sides of the bracket 12. The bracket 12 comprises a bottom plate 121 and a side plate 122 vertically disposed on two sides of the bottom plate 121, respectively, so that the depressed area 11 is formed on the bottom plate 121 between the two side plates 122. Each of the raising portions 13 comprises an extension plate 131 vertically disposed on the side plate 122 and a plurality of reinforcing plate 132 disposed between the side plate 122 and the extension plate 131.

Each of the jacks 2 is disposed on a bottom face of the extension plate 131 of a corresponding one of the raising portions 13.

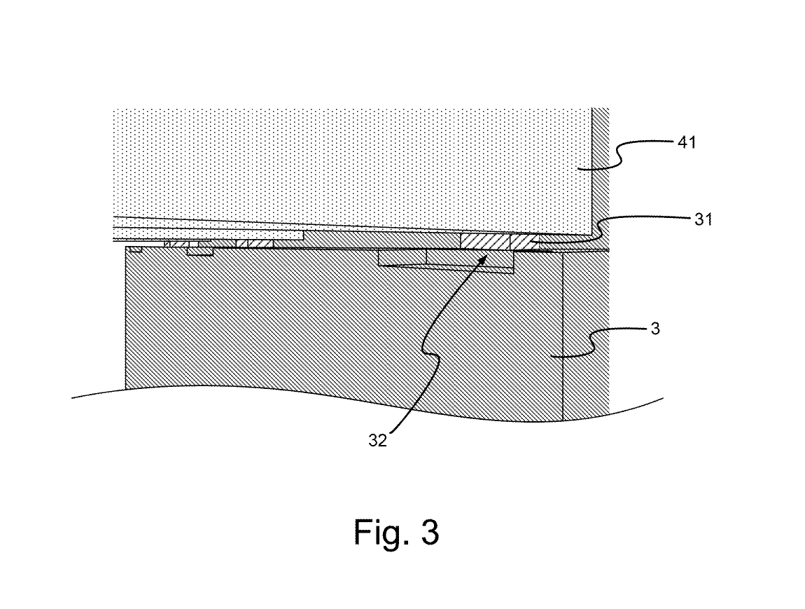

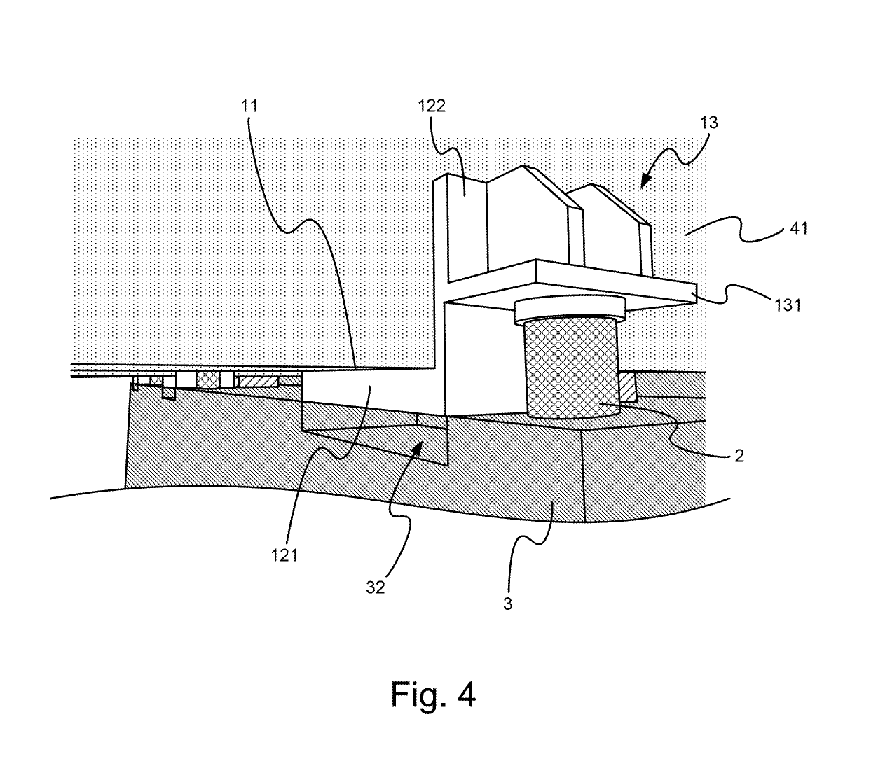

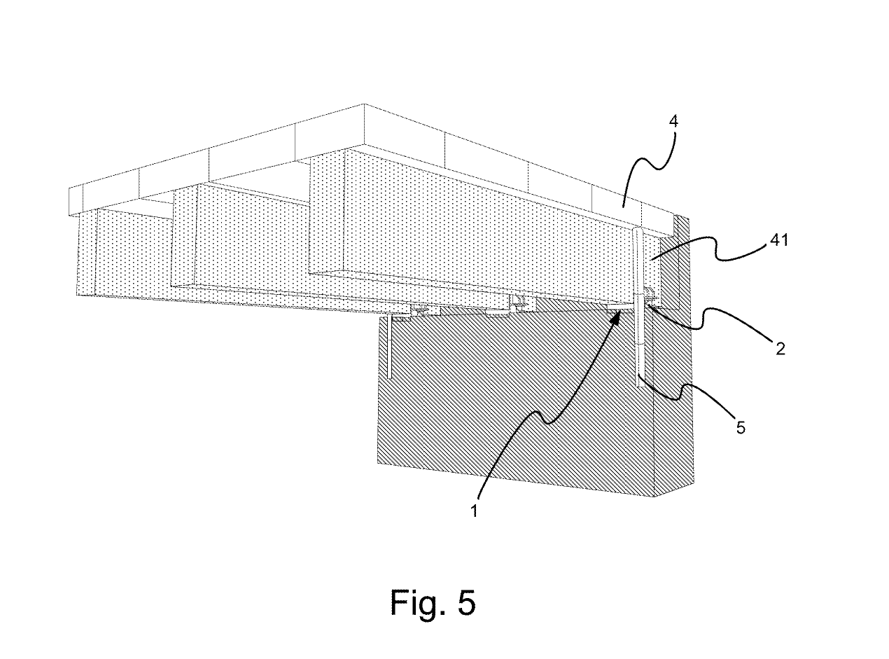

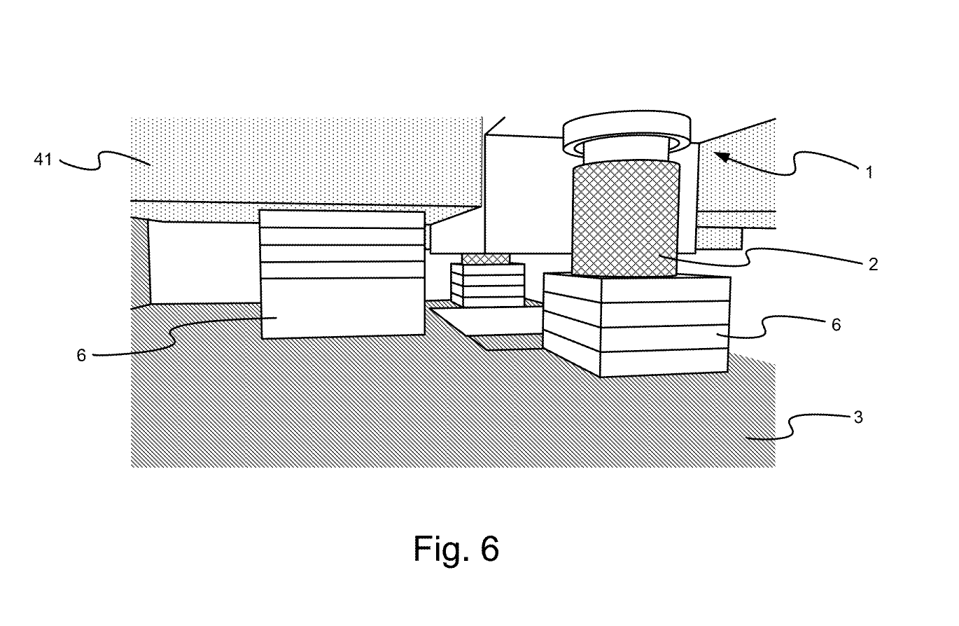

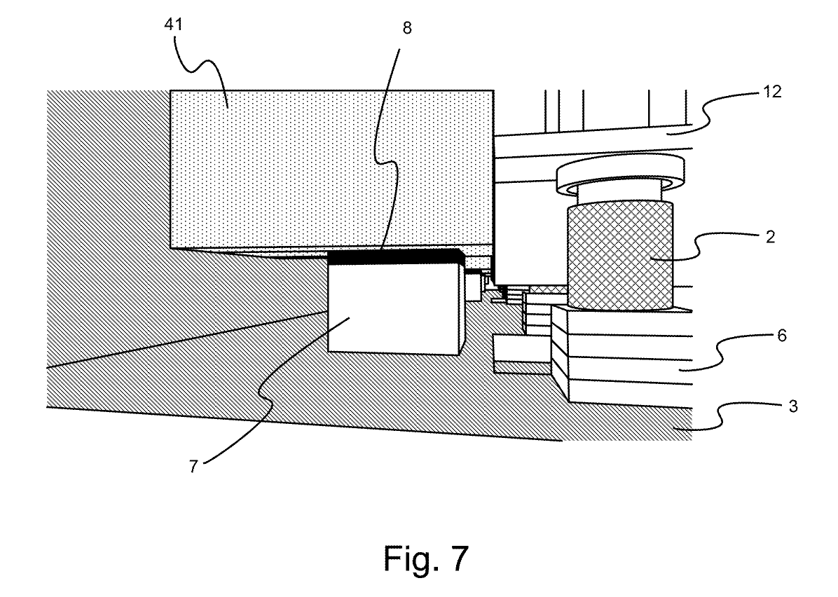

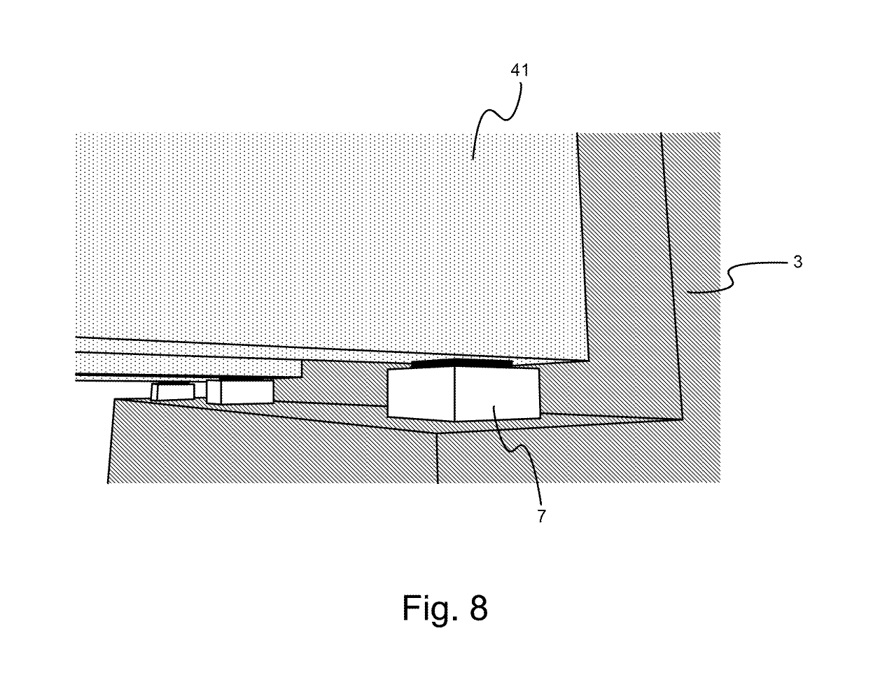

Referring to FIG. 3 through FIG. 8, schematic diagrams of using the present invention are shown, respectively. As shown, when the present invention is operated, a concrete protection layer pier 3 lying on the pier 3 at an area in front of the supporting inset 31 and below each of girders 31, so that a reception area 32 is formed in front of the supporting inset 31. And, a plurality of supporting mechanism 1 is arranged across below each of the girders 41 through the depressed area 11 on the bracket 12, so that the bottom plate 121 of the bracket 12 and each of the side plates 122 are used to bear the girders 41. At this time, each of the jacks 2 is disposed between the extension plate 131 of each of the raising portions 13 and the pier 3. After each of the supporting mechanisms 1 and the jacks 2 is disposed, a position limiting mechanism 5 is disposed on a face of the pier 3 at a place neighboring to the supporting mechanisms 1, so as to exempt the bridge from falling.

Afterwards, each of the supporting mechanisms 1 below each of the girders 41 raises the bridge 4. The supporting inset 31 is not removed until the bridge 4 is raised up to a predetermined altitude. Then, an inset 6 is placed into below each of the girders 41. And, after each of the jacks 2 is positioned, an inset 6 is also placed there below. Then, the process of simultaneously raising each of the jacks 2 and placing the inset 6 is repeated. When the bridge 4 is raised up to the predetermined altitude (when the bridge 4 is raised up to the predetermined altitude course, an additional rushing height is required). The supporting inset originally used is torn down, and a new reinforced concrete inset 7 is poured. On the new reinforced concrete inset 7, a rubber bearing Inset 8 is arranged. Then, the bridge 4 lowered to the bridge body and the weight of the bridge body is born instead shifted to the new bearing inset 7.

Finally, each of the supporting mechanism 1, jacks 2 and the inset 6 under the jacks 2, and the position limiting mechanism 5 are removed. Further, the reception area 32 is filled back with a shrinkage-free mortars. As such, the bridge raising operation is finished. This inventive technology by using the supporting mechanisms 1 and jacks 2 for raising process may have at least the following advantages.

1.The bracket 12 of the supporting mechanisms 1 is combined with the bottom side and the two lateral sides of the girders 41 as a weight bearing station. Along further with a force for raising the bracket 12, the upper structure of the bridge 4 is raised overall. And, each of the jacks 2 is placed on the currently available bridge body structure. After the force is shifted, the jacks 2 are loaded on a stable basis. This may ensure a safety of the raising operation, and the tooling and instrument set-up associated with this process may maintain a preferred construction line.
2. When seams between the bridge 4 and the pier 3 are narrow, and various types of jacks may not be placed between the above two structures, the supporting mechanisms 1 and the jacks 2 in the present invention may be used to seek a raising work space, whereby raising the bridge 4.
3. The longitudinal and lateral force distribution on the supporting mechanisms 1 is analyzed according to the bridge 4 structure, in which the vertical weight bearing average distributed across each of the jacks 2, and the longitudinal and lateral forces are distributed across the position limiting mechanism 5, so that the bridge body is assured as having only a vertical movement. In this manner, the bridge raising process may be avoided with any accidental occurring brought about from an external force collision or sudden earthquake, whereby assuring safety of bridge raising construction.

In view of the above, the bridge lifting support bracket is disclosed, which comprises a supporting mechanism, comprising a bracket having a depressed area at a face thereof and a raising portion disposed at two sides of the bracket, respectively; and at least two jacks, disposed on a bottom face of the raising portions, respectively. As such, a space for receiving a jack properly is secured by digging out a space of a concrete protection layer of a lower structure and using a supporting mechanism cooperating therewith when only a small space or a closely tight bonding with no seam existing between a bridge and a pier, whereby a raising process of the bridge may be safely performed.

The above described is merely examples and preferred embodiments of the present invention, and not exemplified to intend to limit the present invention. Any modifications and changes without departing from the scope of the spirit of the present invention are deemed as within the scope of the present invention. The scope of the present invention is to be interpreted with the scope as defined in the claims.

What is claimed is:

1. A bridge lifting support bracket, comprising:
a supporting mechanism, comprising a bracket having a depressed area at a face thereof and a raising portion disposed at two sides of the bracket, respectively; and
at least two jacks, disposed on a bottom face of the raising portions, respectively.

2. The bridge lifting support bracket as claimed in claim 1, wherein the bracket comprises a bottom plate, and a side plate disposed vertically at two sides of the bottom plates, respectively, so that a depressed area is formed on the bottom plate between the two side plates and each of the raising portions are disposed on an outer side face of the side plates, respectively.

3. The bridge lifting support bracket as claimed in claim 2, wherein each of the raising portions comprises an extension plate vertically disposed on the side plate, and a plurality of reinforcing plates disposed between the side plates and the extension plate, and each of the jacks are disposed on a bottom face of the extension plate, respectively.

4. The bridge lifting support bracket as claimed in claim 1, wherein each of the jacks have a plurality of insets at the bottom side thereof according to a raising altitude.

5. The bridge lifting support bracket as claimed in claim 1, wherein a position limiting mechanism is disposed neighboring to the supporting mechanism for safety.
